(19) United States
(12) Patent Application Publication
(10) Pub. No.: US 2011/0061543 A1
(43) Pub. Date: Mar. 17, 2011

(54) Size adjustable charcoal holder or carrier to be inserted into a new or existing barbeque below the grills to temporarily convert the barbeque into to a charcoal burning barbeque

(76) Inventors: John Ingrassia, Gaithersburg, MD (US); Mikel M. Draghici, Gaithersburg, MD (US)

(21) Appl. No.: 12/589,543

(22) Filed: Sep. 15, 2009

(51) Int. Cl. A47J 37/07

(52) U.S. Cl. 99/340

(57) ABSTRACT

An apparatus configured to permit the use of charcoal for cooking in barbecue grills designed for heating sources other than charcoal. The existing barbecue grill having a bottom casing containing one or more of a variety of heating sources (i.e. propane, natural gas, wood, electric, infrared and others), a cooking rack or grill supported thereabove, and a top casing, hood, or other closure affixed or not affixed thereto. The apparatus includes a size adjustable charcoal tray or carrier designed to be inserted into the lower casing of the existing barbecue grill below the cooking rack or grills, with a pair of removable handles to allow placement of the unit into the host barbecue and subsequent removal of the unit under hot or cold conditions.

### TECHNICAL FIELD

The present invention relates generally to barbecue grills, and, more particularly, to a charcoal tray for use in barbecue grills designed for heating sources other than charcoal.

### DESCRIPTION OF THE PRIOR ART

The use of gas and other types of grill converters is known in the prior art. More specifically, such converters heretofore devised and utilized are known to consist basically of familiar, expected and obvious structural configurations.

While these devices fulfill their respective, particular objectives and requirements, the aforementioned patents do not disclose a new apparatus to permit the use of charcoal for cooking in barbecue grills designed for heating sources other than charcoal while achieving full cooking surface heat coverage. The inventive device includes a container for holding flammable material (i.e. charcoal). The container is removably positionable in the interior of the host barbecue. The container is positionable on the heating system within the housing of the host barbecue and is size adjustable for length and width. The flammable material is placed in the container and ignited. The grill racks are replaced to allow cooking.

In these respects, the apparatus to permit the use of charcoal for cooking in barbecue grills designed for heating sources other than charcoal according to the present invention substantially departs from the conventional concepts and designs of the prior art because none presented have been adjustable to fit host barbecues of varying sizes and none achieve full cooking surface heat coverage, and in so doing the present invention provides an apparatus primarily developed for the purpose of conveniently using charcoal or other flammable material in a barbecue grill designed for heating sources other than charcoal while achieving full cooking surface heat coverage.

### BACKGROUND OF THE INVENTION

Outdoor cooking is a great American pastime that has experienced tremendous growth. In large measure, this is a result of significant improvements in to barbecue grill technology, making them easier to use and enjoy, and more efficient at cooking a wide range of food items. Although charcoal barbecue grills and barbecue grills employing other heating and fuel sources have seen improvements in the recent years, the advantages certain fuel sources (i.e. natural gas or propane) have been well recognized for their ability to quickly bring a heated surface to a desired temperature and to provide a high rate of heat exchange. These types of barbecue grills generally require less time to prepare food items than the charcoal grills and allow for finer control of cooking temperatures than do charcoal barbecue grills. Still, many prefer cooking with a charcoal barbecue grill for some or all cooking events.

Charcoal barbecue grills offer a number of advantages as well. For example, charcoal barbecue grills tend to be of simple construction, and therefore, tend to cost less than other types of barbecue grills. Many also prefer the flavor imparted to food cooked with charcoal.

The Krall patent, U.S. Pat. No. 6,173,644, issued Jan. 16, 2001, discloses an apparatus for converting a gas grill into a charcoal burning grill for conveniently using charcoal or other flammable material in a gas grill. The invention disclosed in the Krall patent includes a container for holding flammable material that is removably positionable in the interior of the barbecue housing. Once the adapter container is positioned in the housing, a screen that is removably supported by the housing is replaced such that the screen covers the adapter container. However, because the screen is supported by the housing, the height of the screen above the adapter container can not be easily adjusted. The adapter container also is not size adjustable. Therefore its use is limited to barbecue grills that it will fit into, and for those that the adapter container will fit into, complete heat or flame coverage of the cooking surface is not provided.

Therefore, a need exists for improved barbecue grills that can more effectively function in both the charcoal mode as well as other fuel and heat sources.

### SUMMARY OF THE INVENTION

Embodiments of the present invention include an apparatus designed to permit the use of charcoal for cooking in barbecue grills designed for heating sources other than charcoal. The existing barbecue grill having a bottom casing containing one or more of a variety of heating sources (i.e. propane, natural gas, wood, electric, infrared and others), a cooking rack or grill supported thereabove, and a top casing, hood, or other closure affixed or not affixed thereto. The apparatus includes a size adjustable charcoal tray or carrier designed to be inserted into lower casing of the existing barbecue grill below the cooking rack or grills, with a pair of removable handles to allow placement of the unit into the host barbecue and subsequent removal of the unit under hot or cold conditions.

Other features and advantages of the present invention will become apparent to one with skill in the art upon examination of the following drawings and detailed description. It is intended that all such features and advantages be included herein within the scope of the present invention, as defined in the appended claims.

It is an object of the present invention to provide a new apparatus which will quickly and easily provide charcoal burning capability to any barbecue and which may be easily and efficiently manufactured and marketed at a low cost relative to the host barbecue. It is a further object of the present invention to provide a new apparatus of a durable and reliable construction that will temporarily convert any barbecue into a charcoal burning barbecue grill and that is size adjustable to provide complete heat or flame coverage of the cooking surface.

### BRIEF DESCRIPTION OF THE DRAWINGS

The present invention, as defined in the claims, can be better understood with reference to the following drawings. The components in the drawings are not necessarily to scale relative to each other, emphasis instead being placed upon clearly illustrating the principles of the present invention.

FIG. 1 is a perspective view of a host barbecue grill including a size adjustable removable charcoal tray and associated cooking rack constructed according to an embodiment of the present invention.

FIG. 2 is a perspective view of the apparatus.

FIG. 3 is a perspective view of the apparatus in its disassembled state.

### DETAILED DESCRIPTION OF THE PREFERRED EMBODIMENT

In the following detailed description, reference is made to the accompanying drawings which form a part hereof, and in which are shown by way of illustration of specific embodiments of the apparatus to permit the use of charcoal for cooking in barbecue grills designed for heating sources other than charcoal. It is to be understood that other embodiments may be utilized and that structural or process changes may be made. The following detailed description, therefore, is not to be taken in a limiting sense.

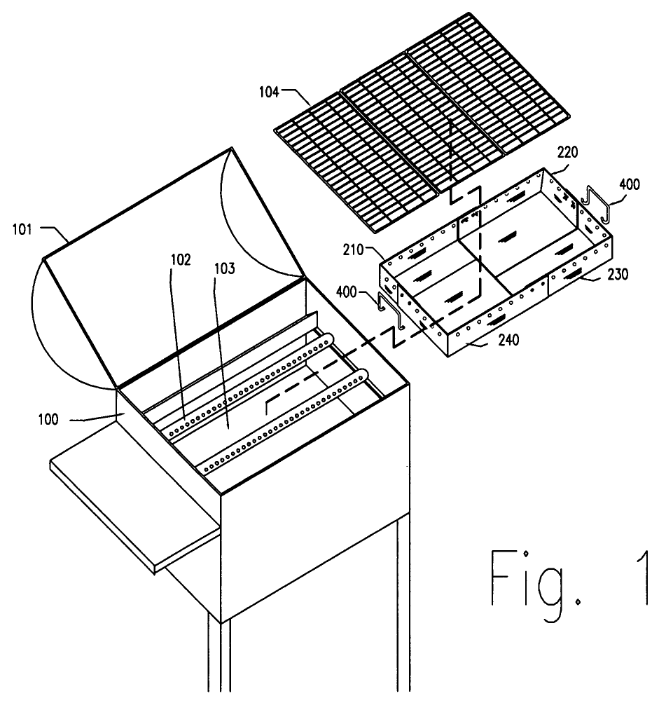

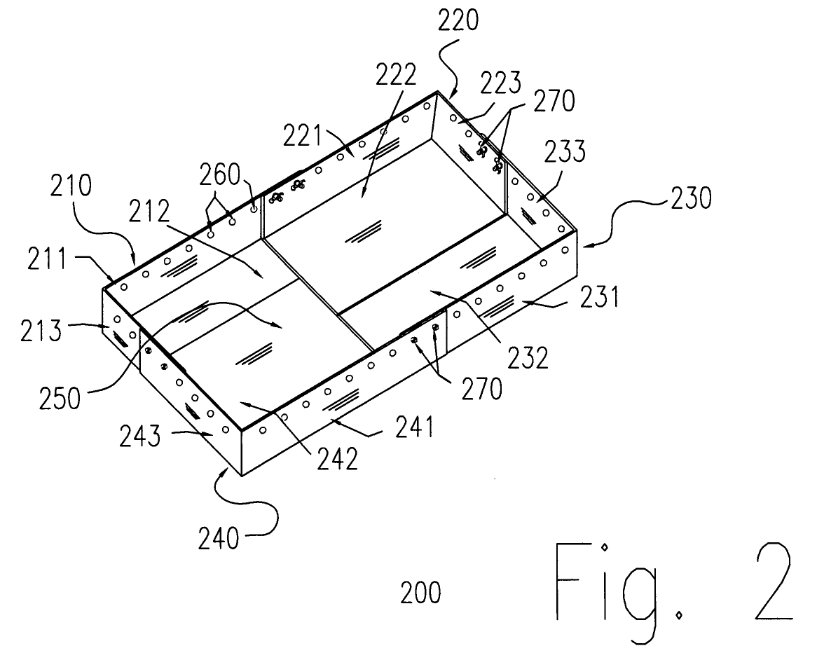

Referring now to the figures, wherein like reference numerals indicate corresponding components throughout the several views. One example of a size adjustable tray or carrier to permit the use of charcoal for cooking in barbecue grills designed for heating sources other than charcoal in accordance with the present invention is illustrated in FIG. 1. A preferred embodiment illustrated in FIG. 2 includes a length and width adjustable charcoal tray or carrier 200 made of four separate square or rectangular three sided corner modules 210/220/230/240 conjoined with set screws 270 placed into holes 260 existing at regular intervals on the upright walls 212/222, 223/233, 231/241 and 243/213 of the assembled unit 200. The unit is disposed within the bottom casing 103 of a barbecue 100, above the heating element(s) 102.

The fully assembled apparatus 200 includes a floor 250 comprised of four separate surfaces 212/222/232/242, a front wall 241/231, a back wall 211/221, a pair of side walls 223/233 and 213/243 and a pair of removable handles 400. The charcoal tray 200 is sizable to substantially span the interior of the bottom casing of the host barbecue 103. For convenience, the apparatus 200 is provided with a pair of removable handles 400 to allow placement of the unit into the host barbecue 100 and subsequent removal of the unit 200 under hot or cold conditions. The apparatus 200 can also be sized such that it does not span the entire interior of the host barbecue 100. Such embodiments allow the host barbecue 100 to be used in dual fuel mode simultaneously.

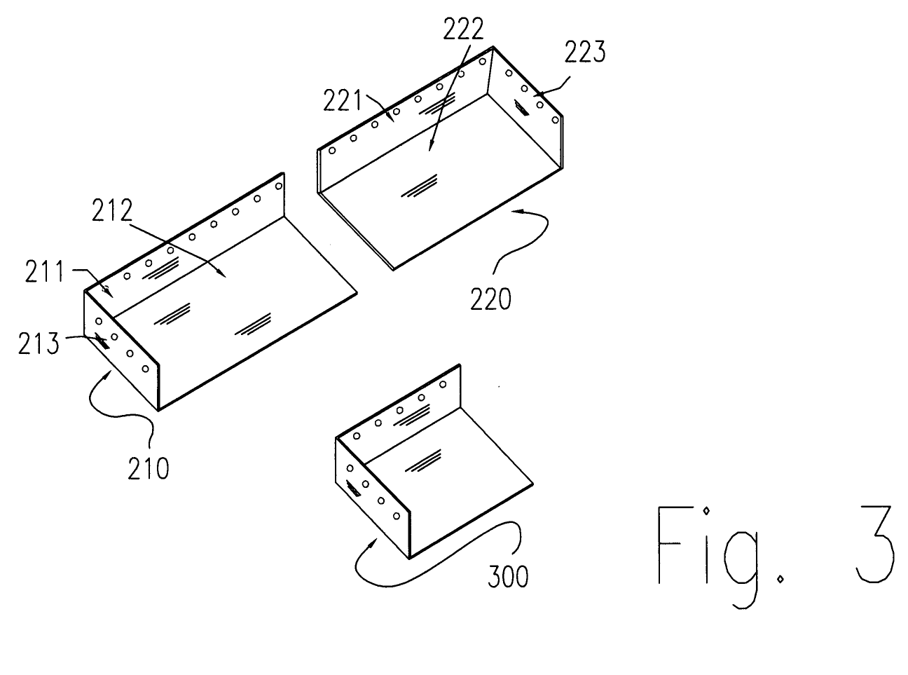

FIG. 3 illustrates the corner modules of the disassembled unit in the alternative embodiments of rectangle 210/220 and square 300.

### Operation

As previously noted, the charcoal tray 200 allows any barbecue 100 to be operated in a charcoal mode. To operate in the charcoal mode, the charcoal tray 200 is inserted into the host barbecue 100 and is placed in the bottom casing 103 above the burner elements 102 (FIG. 1). Preferably, the handles 400 are removed during cooking events to allow them to remain cool to the touch for later reinstallation to remove the apparatus from the host barbecue 100. Charcoal or other flammable material is placed in the apparatus 200 and ignited. Ignition of the charcoal can be accomplished with an external flame, such as a match, lighter, etc. Shortly after ignition, the cooking grills 104 are reinserted, and the lid 101 may be closed.

During primary fuel mode operations, the apparatus 200 is removed from the host barbecue 100, as is shown in FIG. 1.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. An apparatus designed to permit the use of charcoal for cooking in barbecue grills designed for heating sources other than charcoal. The existing barbecue grill having a bottom casing containing one or more of a variety of heating sources (i.e. propane, natural gas, wood, electric, infrared and others), a cooking rack or grill supported thereabove, and a top casing, hood, or other closure affixed or not affixed thereto. The apparatus includes a size adjustable charcoal tray or carrier designed to be inserted into lower casing of the existing barbecue grill below the cooking rack or grills, with a pair of removable handles to allow placement of the unit into the host barbecue and subsequent removal of the unit under hot or cold conditions.

2. The apparatus of claim 1, further comprising four separate square or rectangular three-sided corner units positionable into a square or rectangular open top box of fixed height but varying length and width through the use of holes placed at fixed intervals on the side walls of the apparatus and set screws to affix the four corner units into a complete square or rectangle.

3. The apparatus of claim 1, wherein said removable handles include hooking mechanisms designed to secure said handles to the apparatus for placement of the unit into the host barbecue and the subsequent removal of the unit under hot or cold conditions.
